(19) United States
(12) Patent Application Publication
(10) Pub. No.: US 2025/0200547 A1
(43) Pub. Date: Jun. 19, 2025

(54) IN-PERSON PEER-TO-PEER TRANSFER USING TAP

(71) Applicant: VISA INTERNATIONAL SERVICE ASSOCIATION, San Francisco, CA (US)

(72) Inventors: Jarkko Oskari Sevanto, Berkeley, CA (US); Micael De Torres Gomes, Alameda, CA (US); Vikram Modi, Lafayette, CA (US)

(73) Assignee: VISA INTERNATIONAL SERVICE ASSOCIATION, San Francisco, CA (US)

(21) Appl. No.: 18/846,914

(22) PCT Filed: Mar. 29, 2023
(86) PCT No.: PCT/US2023/000012

§ 371 Date: Sep. 13, 2024

Related U.S. Application Data
(60) Provisional application No. 63/325,104, filed on Mar. 29, 2022.

(51) Int. Cl. G06Q 20/22; G06Q 20/32; G06Q 20/34

(52) U.S. Cl. CPC G06Q 20/223; G06Q 20/326; G06Q 20/3278; G06Q 20/353

(57) ABSTRACT

Embodiments allow a user of a first user device transfer funds to a recipient having a second user device. The first user device includes a communication device including a transfer application linked to a first account of the user. The second user device includes a payment card or a communication device that does not have the transfer application. Tapping the first user device to the second user device transmits an account identifier of a recipient account from the second user device to the first user device. The transfer application receives the recipient account identifier and an amount to be transferred to the recipient account. The transfer application generates a push request and transmits the push request to the processing network, which coordinates debiting the amount to the first account and crediting the amount to the recipient account.

### CROSS-REFERENCES TO RELATED APPLICATIONS

This application claims benefit under 35 USC § 119(e) to U.S. Provisional Patent Application No. 63/325, 104 filed Mar. 29, 2022 and entitled “In-Person Peer-To-Peer Transfer Using Tap”, the disclosure of which is incorporated by reference herein in its entirety for all purposes.

### BACKGROUND

Peer-to-peer transfer of funds refers to a first person transferring funds from a user account of the first person to a user account of a second person.

Various systems directed to peer-to-peer transfers require the first person to enter the account information of the recipient on a platform. This action is prone to human error and may result in a wrong account identifier being used for the transfer. Other systems rely on using a transfer platform (e.g., Venmo, Zelle) that require both parties (i.e., the sender and the recipient) to have an account with (e.g., to be registered with) the transfer platform.

Embodiments of the disclosure address these and other problems individually and collectively.

### SUMMARY

Embodiments provide a method that comprises interacting, by the first user device, with a second user device. The method further comprises receiving, by a transfer application on the first user device from the second user device, a second user account identifier. The method also comprises transmitting, by the transfer application to a processing network, a push transfer message comprising at least an amount and the second user account identifier. The processing network transmits the push transfer message to a second authorizing entity computer that credits the amount to a second user account associated with the second user account identifier.

Embodiments further provide a system comprising a first user device comprising one or more processors, and a memory storing a transfer application and instructions that, when executed by the one or more processors, cause the one or more processors to perform the above method.

A better understanding of the nature and advantages of embodiments may be gained with reference to the following detailed description and accompanying drawings.

### BRIEF DESCRIPTION OF THE DRAWINGS

FIG. 1 shows a first user device and a second user device, according to embodiments.

FIG. 2 shows an exemplary user interface displayed on a first user device, according to embodiments.

FIG. 3 shows exemplary user interfaces displayed on a first user device and a second user device, according to embodiments.

FIG. 4 shows a block diagram of a first user device transferring an amount to a second user device, according to embodiments.

FIG. 5 shows a block diagram of a processing network computer, according to embodiments.

FIG. 6 shows a block diagram of an exemplary user device, according to some embodiments.

### DETAILED DESCRIPTION

Prior to discussing embodiments of the disclosure, some terms can be described in further detail.

A “user” may include an individual. In some embodiments, a user may be associated with one or more personal accounts and/or mobile devices. The user may also be referred to as a cardholder, account holder, or consumer in some embodiments.

A “user device” may be any suitable device that a user can interact with (e.g., a payment card or mobile phone). User devices may be in any suitable form. Some examples of user devices include cards (e.g., payment cards such as credit, debit, or prepaid cards) with magnetic stripes or contactless elements (e.g., including contactless chips and antennas), cellular phones, PDAs, personal computers (PCs), tablet computers, and the like. In some embodiments, where a user device is a mobile device, the mobile device may include a display, a memory, a processor, a computer-readable medium, and any other suitable component.

A “mobile device” (sometimes referred to as a mobile communication device) may comprise any suitable electronic device that may be transported and operated by a user, which may also provide remote communication capabilities to a network. A mobile communication device may communicate using a mobile phone (wireless) network, wireless data network (e.g., 3G, 4G or similar networks), Wi-Fi, Bluetooth, Bluetooth Low Energy (BLE), Wi-Max, or any other communication medium that may provide access to a network such as the Internet or a private network. Examples of mobile devices include mobile phones (e.g., cellular phones), PDAs, tablet computers, net books, laptop computers, wearable devices (e.g., watches), vehicles such as automobiles and motorcycles, personal music players, hand-held specialized readers, etc. A mobile device may comprise any suitable hardware and software for performing such functions, and may also include multiple devices or components (e.g., when a device has remote access to a network by tethering to another device—i.e. using the other device as a modem—both devices taken together may be considered a single mobile device).

A “payment device” may include any suitable device that may be used to conduct a financial transaction, such as to provide payment credentials to a merchant. The payment device may be a software object, a hardware object, or a physical object. As examples of physical objects, the payment device may comprise a substrate such as a paper or plastic card, and information that is printed, embossed, encoded, or otherwise included at or near a surface of an object. A hardware object can relate to circuitry (e.g., permanent voltage values), and a software object can relate to non-permanent data stored on a device. A payment device may be associated with a value such as a monetary value, a discount, or store credit, and a payment device may be associated with an entity such as a bank, a merchant, a payment processing network, or a person. A payment device may be used to make a payment transaction. Suitable payment devices can be hand-held and compact so that they can fit into a user's wallet and/or pocket (e.g., pocket-sized). Example payment devices may include smart cards, magnetic stripe cards, keychain devices (such as the Speedpass™ commercially available from Exxon-Mobil Corp.), etc. Other examples of mobile devices include pagers, payment cards, security cards, access cards, smart media, transponders, and the like. If the payment device is in the form of a debit, credit, or smartcard, the payment device may also optionally have features such as magnetic stripes. Such devices can operate in either a contact or contactless mode. In some embodiments, a mobile device can function as a payment device (e.g., a mobile device can store and be able to transmit payment credentials for a transaction).

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer”.

An “authorizing entity” may be an entity that authorizes a request. Examples of an authorizing entity may be an issuer, a governmental agency, a document repository, an access administrator, etc. An “issuer” may typically refer to a business entity (e.g., a bank) that maintains an account for a user. An issuer may also issue payment credentials stored on a user device, such as a cellular telephone, smart card, tablet, or laptop to the consumer.

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes and other login information, etc.

“Payment credentials” may include any suitable information associated with an account (e.g., a payment account and/or payment device associated with the account). Such information may be directly related to the account or may be derived from information related to the account. Examples of account information may include a PAN (primary account number or “account number”), username, expiration date, and verification values such as CVV, dCVV, CVV2, dCVV2, and CVC3 values. In some embodiments, payment credentials may be any information that identifies or is associated with a payment account. Payment credentials may be provided in order to make a payment from a payment account. Payment credentials can also include a user name, an expiration date, a gift card number or code, and any other suitable information.

An “application” may be computer code or other data stored on a computer readable medium (e.g., memory element or secure element) that may be executable by a processor to complete a task.

A “transfer application” can include an application facilitating the transfer of funds between multiple parties. For instance, a transfer application can include a peer-to-peer transaction application. The transfer application can be executed on a mobile device associated with a user, and the transfer application can be implemented using a server (e.g., application server computer) in communication with the mobile device. The transfer application can provide an account (e.g., from a digital wallet which may be part of the transfer application or external to it) for each user. The transfer application can allow a user to select a recipient user to transfer a specified amount of funds to the recipient user. The transfer application can then transfer the specified amount from an account for the user to an account for the recipient user.

An “application server computer” can be a server computer that is specifically designed to run applications. For instance, an application server computer can perform processing tasks relating to the above-described transfer application, such as provide user account details to be displayed on the transfer application executing on the mobile device or facilitate transfer of funds between users on the transfer application. As described below, the application server computer can identify a digital tag specific to a resource provider, identify a credential from the digital tag, and generate a push transfer message facilitating a transaction via a processing network.

A “digital wallet” can include an electronic device that allows an individual to conduct electronic commerce transactions. A digital wallet may store user profile information, payment credentials, bank account information, one or more digital wallet identifiers and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like. A digital wallet may be designed to streamline the purchase and payment process. A digital wallet may allow the user to load one or more payment cards onto the digital wallet so as to make a payment without having to enter an account number or present a physical card.

A “digital wallet provider” may include an entity, such as an issuing bank or third-party service provider, that issues a digital wallet to a user that enables the user to conduct financial transactions. A digital wallet provider may provide standalone user-facing software applications that store account numbers, or representations of the account numbers (e.g., payment tokens), on behalf of a cardholder (or other user) to facilitate payments at more than one unrelated merchant, perform person-to-person payments, or load financial value into the digital wallet. A digital wallet provider may enable a user to access its account via a personal computer, mobile device or access device. Additionally, a digital wallet provider may also provide one or more of the following functions: storing multiple payment cards and other payment products on behalf of a user, storing other information including billing address, shipping addresses, and transaction history, initiating a transaction by one or more methods, such as providing a user name and password, NFC or a physical token, and may facilitate pass-through or two-step transactions.

A “token” may be a substitute value for a credential. A token may be a string of numbers, letters, or any other suitable characters. Examples of tokens include payment tokens, access tokens, personal identification tokens, etc.

A “payment token” may include an identifier for a payment account that is a substitute for an account identifier, such as a primary account number (PAN). For example, a payment token may include a series of alphanumeric characters that may be used as a substitute for an original account identifier. For example, a token “4900 0000 0000 0001” may be used in place of a PAN “4147 0900 0000 1234.” In some embodiments, a payment token may be “format preserving” and may have a numeric format that conforms to the account identifiers used in existing transaction processing networks (e.g., ISO 8583 financial transaction message format). In some embodiments, a payment token may be used in place of a PAN to initiate, authorize, settle or resolve a payment transaction or represent the original credential in other systems where the original credential would typically be provided. In some embodiments, a payment token may be generated such that the recovery of the original PAN or other account identifier from the token value may not be computationally derived. Further, in some embodiments, the token format may be configured to allow the entity receiving the token to identify it as a token and recognize the entity that issued the token.

A “push transfer message” can include a message that causes value (e.g., funds) to be pushed from one entity to another. In some embodiments, for example, a push transaction message can be generated by the application server computer to initiate a transaction between a user and a resource provider to push funds to the resource provider. In a push transaction, the funds transfer messaging is not first initiated by the intended recipient of the funds. The push transfer message can include user account details, a credential (identified from the digital tag) relating to the resource provider, and a transaction amount. In some instances, the push transfer message can comprise an original credit transaction (OCT) format.

A “settlement process” can is a process in which funds are actually delivered from one entity to one or more other entities to fulfil a transaction.

A “server computer” may include a powerful computer or cluster of computers. For example, the server computer can be a large mainframe, a minicomputer cluster, or a group of servers functioning as a unit. In one example, the server computer may be a database server coupled to a web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, AMD Ryzen, AMD Threadripper, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

Details of some embodiments of the present disclosure will now be described in greater detail. For clarity, a certain number of components are shown in the subsequent figures. It is understood, however, that embodiments of the disclosure may include more than one of each component. In addition, the components in each figure may communicate via any suitable communication medium (including the internet), using any suitable communication protocol.

Embodiments allow a user to transfer funds to a recipient. Specifically, the user may operate a first user device. In some embodiments, the first user device may be a portable user device such as a mobile communication device. A transfer application may be installed on the first user device, and linked to (e.g., associated with) a first user account of the user. The user may activate (e.g., launch) the transfer application on the first user device and enter an amount to be transferred to a second user account of the recipient from the first user account of the user. Once the transfer is set up, the transfer application may ask the user to bring the first user device in close proximity of (e.g., tap) a second user device of the recipient. For example, the second user device may be a payment card. In some embodiments, the second user device may be a second mobile communication device. Either way, the second user device does not have or is not associated with the transfer application in any way. That is, the first user device, the transfer application and the second user device are part of (e.g., form) an open network. When the first user device and the second user device are in close proximity, the first user device receives the second user account information from the second user device. The transfer application then generates a push request to transfer the specified amount from the first user account of the user to the second user account (identified by the second user account information) of the recipient. The transfer application transmits the push request to the processing network via, for example, a transport computer. The processing network may debit the amount to the first user account issued and/or managed by the first authorizing entity computer, and credit the amount to the second user account issued and/or managed by the second authorizing entity computer. Upon receipt of funds, the second authorizing entity computer may send a notification to the second user (e.g., to a communication device of the second user). For example, if the second user device is a communication device, the second authorizing entity computer may send a push notification, a text message, an email message, a voice message, a call to the second user device.

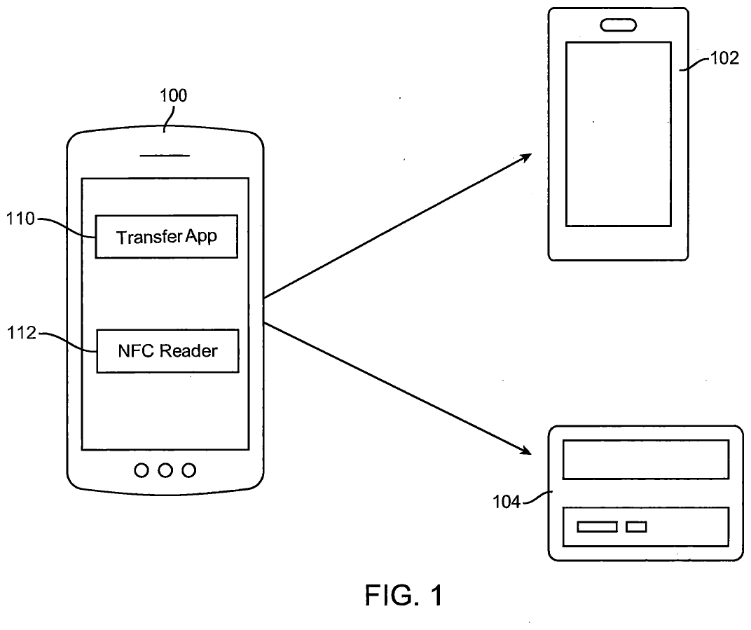

FIG. 1 shows a first user device and a second user device according to embodiments. The first user device 100 may be a communication device (e.g., a mobile phone) operated by a first user (e.g., sender). In some embodiments, the first user device 100 may have a transfer application 110 installed thereon. The transfer application 110 may be managed by a transfer server. The user may download the transfer application 110 on the first user device 100 and may set up the transfer application 110 by linking a first user account of the user issued and/or managed by a first authorizing entity to the transfer application 110. For example, the transfer application 110 installed on the first user device 100 may store an account identifier, a token or any other credential that identifies the first user account of the first user.

The first user device 100 may comprise a Near Field Communication (NFC) reader 112, which can be used to communicate with a second user device. In some embodiments, the second user device may be a payment card 104 such as a credit card, a debit card or a prepaid card. The payment card 104 may include a memory for storing account identifying information, and one or more semiconductor chips (e.g., EMV chip) embedded within a substrate of the payment card 104. The embedded chip(s) configure the payment card 104 to communicate over short range radio frequency waves (RF) for secure data communication (e.g., for transmitting account identifier to the first user device 100). The payment card 104 may be activated using the energy from the first user device 100 when the first user device 100 and the payment card 104 are in close proximity. Accordingly, the payment card 104 does not include a power source (e.g., a battery). The payment card 104 may obtain power from the first user device 100 via am inductive coil (e.g., an antenna) coupled to the chip.

In some embodiments, the second user device may be a second user phone 102 (e.g., a mobile phone) operated by a second user. In some embodiments, the second user phone 102 may comprise the second user device 104 (e.g., a digital wallet application storing a virtual payment card). According to various embodiments, the first user device 100 is configured to receive or retrieve an account identifier, a token or any other credential that identifies an account of a second user (e.g., a second user account) via NFC capability of both the first user device 100 and the second user device 102, 104.

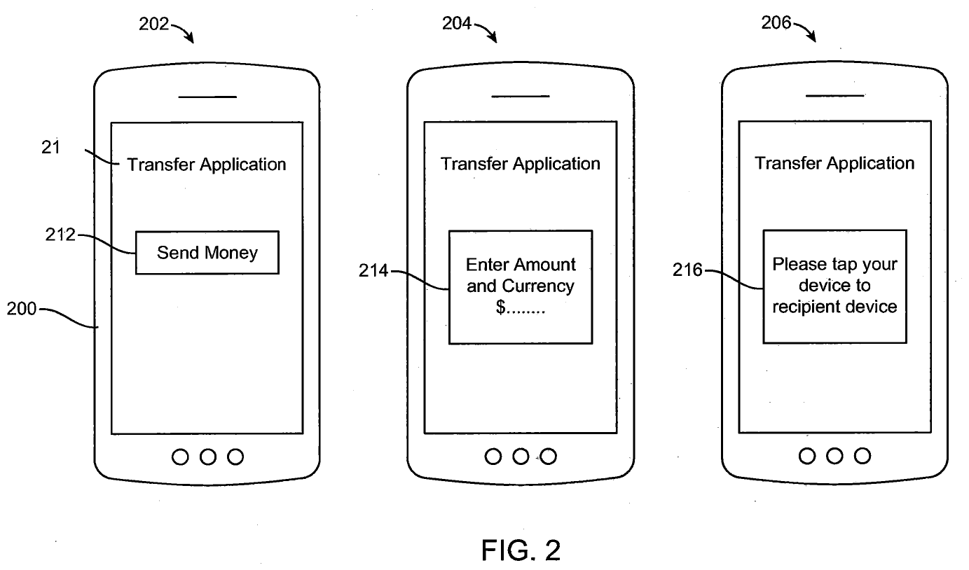

FIG. 2 illustrates an exemplary user interface displayed on the first user device, according to embodiments. The user may launch and/or activate the transfer application 210 on the first user device 200. A first graphical user interface 202 displayed on the first user device 200 may provide the first user an option 212 to send funds (e.g., money) to a recipient. The first user may select the option 212, which may lead to a second graphical user interface 204 to be displayed on the first user device 200. The second graphical user interface 204 may include a field 214 for the first user to enter an amount and currency. The transfer application 210 may receive the amount and currency from the first user via the field 214. As explained above, the transfer application 210 is linked to the first user account of the first user. As such, the transfer application 210 has access to the account identifier for the first user account of the first user. In some embodiments, the transfer application 210 may include a stored value digital wallet. In such embodiments, the transfer application 210 may deduct the amount from the stored value maintained by the transfer application 210.

To effectuate the transfer, the transfer application 210 needs the account identifier for the recipient account. In some embodiments, after the first user provides the amount and the currency at the field 214, a third graphical user interface 206 may be displayed on the first user device 200. The third graphical user interface 206 may include a prompt 216 asking the first user to tap the first user device 200 to a second user device of a recipient (or otherwise bring the first user device 200 in close proximity of the second user device). When the second user device is in close proximity of the first user device 200 (as shown, for example in FIG. 1), the transfer application 210 may retrieve the second user account information (e.g., recipient account information) from the second user device. In the embodiment illustrated in FIG. 2, the second user device may be a payment device (e.g., a payment card), or a user communication device (e.g., a second mobile device).

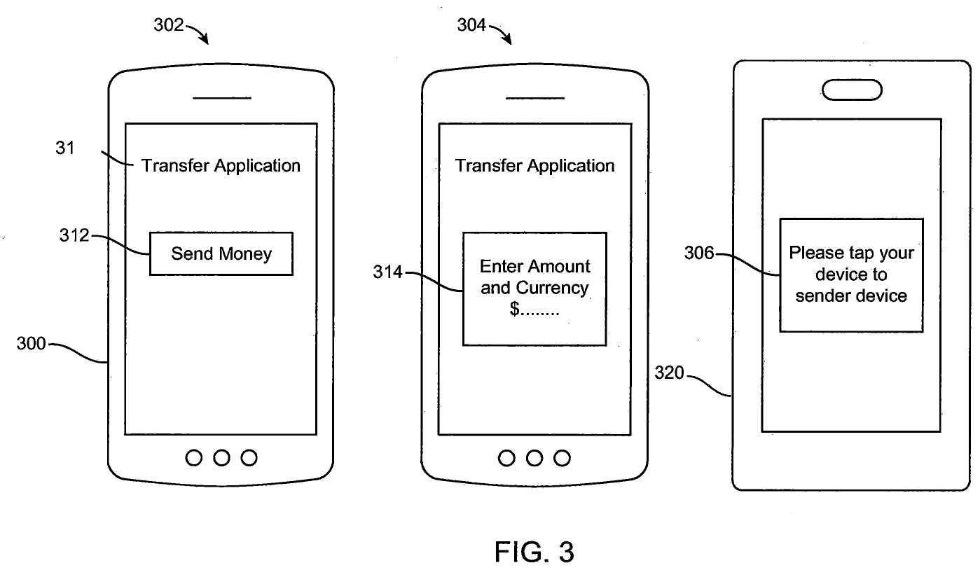

FIG. 3 illustrates an exemplary user interface displayed on the first user device, according to embodiments. The user may launch and/or activate the transfer application 310 on the first user device 300. A first graphical user interface 302 displayed on the first user device 300 may provide the first user an option 312 to send funds (e.g., money) to a recipient. The first user may select the option 312, which may lead a second graphical user interface 304 to be displayed on the first user device 300. The second graphical user interface 304 may include a field 314 for the first user to entre an amount and currency. The transfer application 310 may receive the amount and currency from the first user via the field 314. As explained above, the transfer application 310 is linked to the first user account of the first user. As such, the transfer application 310 has access to the account identifier for the first user account of the first user. In some embodiments, the transfer application 310 may include a stored value digital wallet. In such embodiments, the transfer application 310 may deduct the amount from the stored value maintained by the transfer application 310.

To effectuate the transfer, the transfer application 310 needs the account identifier for the recipient account. In the embodiment illustrated in FIG. 3, the second user device 320 may be a user communication device (e.g., a second mobile device). After the first user provides the amount and the currency at the field 314 of the transfer application 310 on the first user device 300, the transfer application 310 may send a prompt to the second user device 320. The prompt 306 may be displayed on the second user device 320 the second user to tap the second user device 320 to the first user device 300 (or otherwise bringing the second user device 320 in close proximity of the sender device (e.g., the first user device 300). When the second user device 320 is in close proximity of the first user device 300 (as shown, for example in FIG. 1), the transfer application may retrieve the second user account information (e.g., recipient account information, digital tag) from the second user device 320.

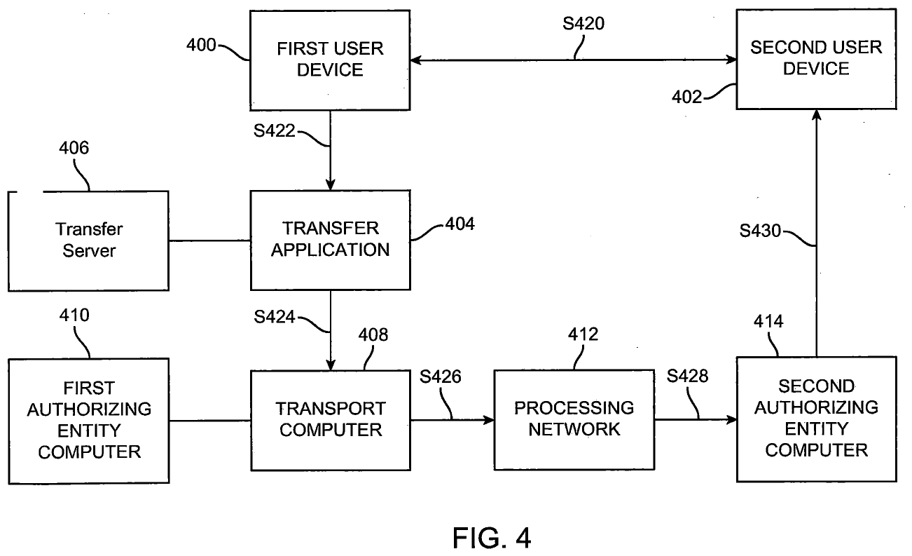

FIG. 4 shows a block diagram of a first user device transferring an amount to a second user device, according to embodiments. FIG. 4 illustrates a first user device 400 of a first user, a transfer application 404 installed on the first user device 400 and managed by a transfer server 406, a second user device 402 of a second user, a first authorizing entity computer 410 associated with a first authorizing entity that issued and/or manages a first user account of the first user, a transport computer 408 (operated, for example, by an acquirer), a processing network 412 (operated, for example, by a payment processor), and a second authorizing entity computer 414 associated with a second authorizing entity that issued and/or manages a second user account of the second user. According to various embodiments, the second authorizing entity may be the same or different from the first authorizing entity.

In various embodiments, the first user account and/or the second user account may include an account for any one of a fiat currency, a digital currency, or a cryptocurrency. For example, an identifier for the first user account and/or the second user account may reference a cryptocurrency wallet, a digital wallet, a fiat currency wallet, or a fiat currency bank account.

The first user downloads and sets up the transfer application 404 on the first user device 400. For example, setting up the transfer application 404 may include the first user linking the first user account issued and/or managed by the first authorizing entity to the transfer application 404 (or to a user account of the first user on the transfer application). According to various embodiments, the transfer application may be a digital wallet (e.g., Apple Cash, Google Pay, Samsung Pay, etc.) supported by the transfer service such an operating system provider (e.g., Apple, Google, Samsung) of the first user device or a developer of the digital wallet. In some embodiments, the transfer application may include an application (e.g., Zelle, Venmo, etc.) supported by the transfer server 406 such as a financial institution (e.g., one or more banks, financial institutions).

At step S420, the first user or the second user can tap the first user device 400 to the second user device 402. The first user device 400 may communicate with the second user device 402 via NFC capability or any other suitable communication medium. After the first user device 400 and the second user device 402 are in communication, the second user device 402 may transmit a second user account identifier (e.g., a PAN, a token of a PAN, a tag, a payment credential) identifying the second user account of the second user to the first user device 400. As described above, the second user device 402 does not have the transfer application 404 or is not associated with the transfer server 406 in any way. That is, a communication network between the first user device, the second user device and a server managing the transfer application is an open network structure such that the second user device is devoid of the transfer application. According to various embodiments, only the second user account identifier is retrieved from the second user device protecting the anonymity of the second user (e.g., the first user device only receives account identifier for the second user account without receiving any additional information identifying the second user such as name, address, ID number, etc.).

At step S422, after receiving the second user account identifier, the first user device 400 may route the second user account identifier to the transfer application 404. Alternatively, the transfer application 404 on the first user device 400 may retrieve the second user account identifier from the second user device 402. Examples of the transfer application 404 can include a digital wallet application or a payment service. In some embodiments, the transfer application 404 may maintain the first user account (e.g., a digital wallet account storing funds), or may be in communication with an external device that maintains the first user account identified by the first user account identifier (e.g., the first authorizing entity computer 410 operated by a bank that maintains a bank account for the first user). The first user may then select an amount in the transfer application 404 to be transferred to the second user account identified by the second user account identifier. In some embodiments, the first user device 400 receiving the second user account identifier may trigger the launch of the transfer application 404.

According to various embodiments, steps S420 and S422 may be performed in reverse order. That is, the method may include first performing step S422 (e.g., launch the transfer application 404 on the first user device 400, provide an amount to be transferred to the transfer application 404), and then performing step S420 (e.g., tap the first user device 400 to the second user device 402 to retrieve the second user account identifier from the second user device 402).

At step S424, after receiving the amount and the second user account identifier, the transfer application 404 may transmit a push transfer message to a transport computer 408. The push transfer message may comprise the amount, the second user account identifier (e.g., second user's PAN or tokenized PAN) retrieved from the second user device 402. In some embodiments, the push transfer message may include the first user account identifier previously provided to and/or stored by the transfer application 404 on the first user device 400. In other embodiments, the push transfer message may include an identifier for the first user device 400 and/or the instance of the transfer application 404 on the first user device 400. The transport computer may identify the first user account based on the identifier for the first user device 400 and/or the instance of the transfer application 404 on the first user device 400. The transport computer may update the push transfer message to incorporate the first user account identifier.

In various embodiments, the push transfer message and/or the data in the push transfer message may be encrypted prior to being forwarded to a recipient entity (e.g., the transport computer and/or the processing network). The recipient entity may decrypt the push transfer message using a decryption key corresponding to an encryption key used by the transfer application 404 to encrypt the push transfer message.

In some embodiments, the push transfer message may be an original credit transaction (OCT) message. An original credit transaction can be a clearing and settlement credit transaction designed for use in business applications such as a business money transfer or business-to-consumer repayments. The OCT can be set up as a transaction used to deliver funds to the recipient account (e.g., the second user account of the second user).

An OCT (Original Credit Transaction) can be a clearing and settlement credit transaction designed for use in business applications such as a business money transfer or business-to-consumer repayments. According to embodiments, the OCT can be used to transfer funds from a first user to a second user (e.g., peer-to-peer transfer). The OCT can be a technique used to deliver funds to the recipient account. It is separate from, and can take place after, an Account Funding Transaction (AFT) in some cases. An AFT can be a technique designed to supply funds to another account such as a credit, prepaid, debit, ATM or on-line account. This timing is to ensure that payment funds are secured before funds are sent to the recipient.

At step S426, the transport computer 408 may transmit the push transfer message to the processing network 412.

At step S428, after receiving the push transfer message from the transport computer, the processing network 412 may transmit the push transfer message to the second authorizing entity computer 414. The processing network 412 may coordinate debiting the amount to the first user account of the first user (identified by the first user account identifier) maintained by the first authorizing entity computer 410, and crediting (e.g., depositing) the amount to the second user account of the second user (identified by the second user account identifier) maintained by the second authorizing entity computer 414.

At step S430, after receiving the push transfer message from the processing network 412, the second authorizing entity computer 414 may credit the amount in the push transfer message to the second user account of the second user (identified by the second user account identifier). In some embodiments, the second authorizing entity computer 414 may transmit a message to a user device of the second user informing the second user of the transfer (e.g., incoming funds).

At a later time, an actual amount may be transferred from the first authorizing entity computer 410 to the second authorizing entity computer 414, via the processing network 412 in a settlement process.

In some embodiments, a second user identifier may be tag or alias for a second user account. The tag or alias could be resolved into a payment credential (e.g., a PAN) in an extra communication step between, for example, the processing network 412 and the second user device 402 or between the processing network 412 and the second authorizing entity computer 414. Further details regarding digital tags can be found in PCT application no. PCT/US2021/030145, which is assigned to the same assignee as the present application and is herein incorporated by reference in its entirety.

According to an exemplary use case scenario, a sender may wish to transfer $50 to a recipient. For example, the sender and recipient may be friends who would like to share a bill at a merchant (e.g., a restaurant). The recipient may pay the bill at the merchant, and the sender may wish to transfer their share (e.g., $50) to the recipient. According to various embodiments, the sender or the recipient may be outside their country of residence or outside of the country that issued the sender user account or the recipient user account. The sender may have a transfer application installed on the sender's user device (e.g., sender's smart phone, wearable, etc.). The transfer application may be a digital wallet linked to a user account of the sender. That is, the transfer application may have the account identifier for the sender user account. In some embodiments, the sender may have funds stored at the transfer server (e.g., the transfer application is a stored value digital wallet). According to various embodiments, the recipient does not have the transfer application installed on their user device. In fact, the recipient user device may simply be a payment card (e.g., a debit card, a credit card, a pre-paid card, etc.) that is not associated with the transfer server in any way. The sender may tap the sender user device to the recipient user device. The recipient user device may transmit (and/or the sender user device may retrieve) account identifier for the recipient user account that is stored on the recipient user device. The sender user device may activate the transfer application (before or after receiving the account identifier for the recipient user account from the recipient user device), and indicate, on the transfer application, the amount and currency (e.g., $50) to be transferred to the recipient user account. The transfer application may then generate a push message including an account identifier for the sender user account linked to the transfer application, the amount to be transferred, and the account identifier for the recipient user account. The transfer application may send the push message to a processing network which may then coordinate debiting the amount to the sender user account issued and/or managed by a first authorizing entity (e.g., a first bank) and crediting the among to the recipient user account issued and/or managed by a second authorizing entity (e.g., a second bank). As mentioned above, the first bank and the second bank may be operating in different localities, or countries. Any required fees (e.g., processing fees, currency conversion fees, etc.) may be charged to one or both of the sender user account or the recipient user account. Accordingly, embodiments allow the sender to send funds to the recipient without the recipient having the transfer application or being associated with the transfer server.

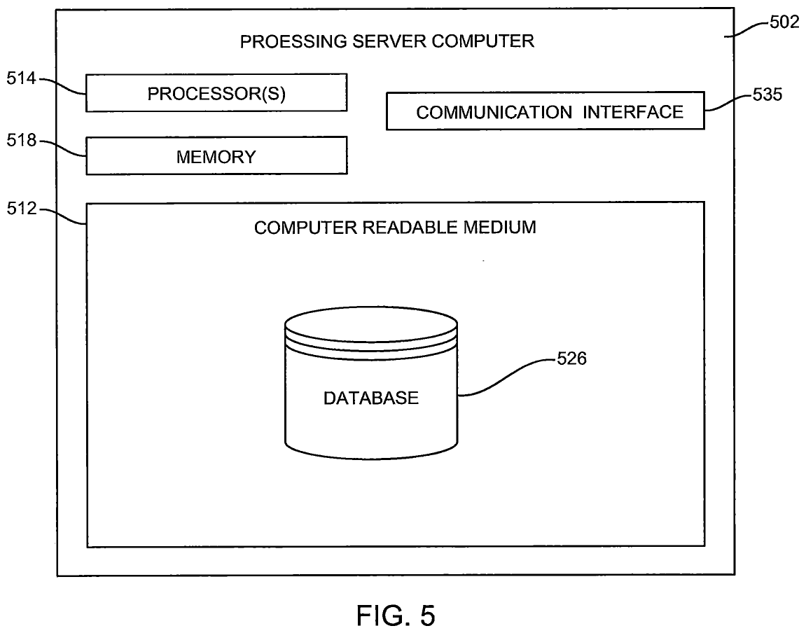

FIG. 5 is a high-level block diagram of a processing network computer that may be used to implement any of the techniques described above. The processing network computer 502 may be provided in form of a server computer, as described above. The subsystems shown in FIG. 5 may be interconnected via a system bus. The interconnection via the system bus allows a central processor 514 to communicate with each subsystem and to control the execution of instructions from system memory or the fixed disk, as well as the exchange of information between subsystems. The communication interface 535 may be used to connect the. processing network computer 502 to a wide area network such as the Internet. The processing network computer 502 can include one or more processor(s) 514, a memory 518, a computer readable medium 512 storing a database 526 for storing information and modules 520, 522, 524, and a network communication interface 535 coupled to the processor(s) 514. The computer readable medium 512 may comprise code that causes the processor(s) 514 to perform the processes (e.g., methods) described herein.

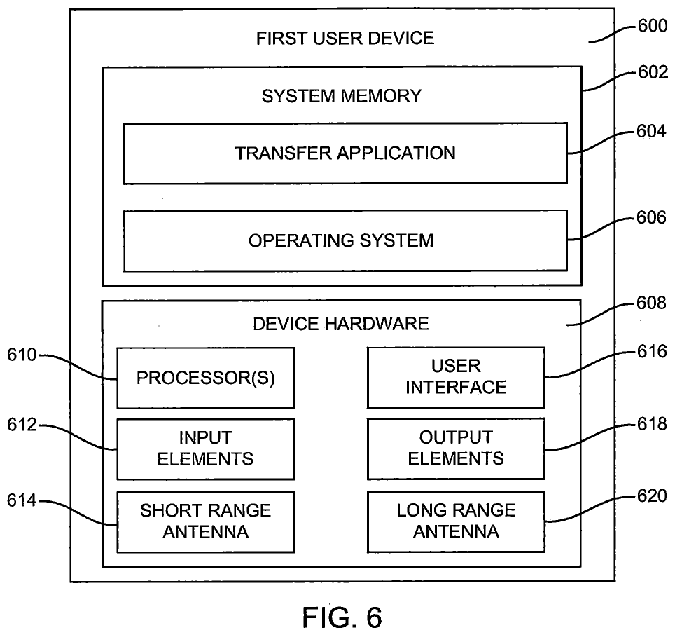

FIG. 6 is a block diagram illustrating an example first user device 600. The first user device 600 can be a mobile device (e.g., mobile phone) with a transfer application (e.g., 604). The first user device 600 can be capable of performing tasks described herein. The first user device 600 may include device hardware 608 coupled to a system memory 602. The first user device 600 can perform the functions described herein.

Device hardware 608 may include a processor 610, input elements 612, a short range antenna 614, a user interface 616, output elements 618, and a long range antenna 620. Examples of input elements may include microphones, keypads, touchscreens, sensors, etc. Examples of output elements may include speakers, display screens, and tactile devices. The processor 610 can be implemented as one or more integrated circuits (e.g., one or more single core or multicore microprocessors and/or microcontrollers), and is used to control the operation of first user device 600. The processor 610 can execute a variety of programs in response to program code or computer-readable code stored in the system memory 602, and can maintain multiple concurrently executing programs or processes.

The long range antenna 620 may include one or more RF transceivers and/or connectors that can be used by first user device 600 to communicate with other devices and/or to connect with external networks. The input and output elements 618, 618 allow a user to interact with and invoke the functionalities of first user device 600. The short range antenna 614 may be configured to communicate with external devices through a short range communication medium (e.g. using Bluetooth, Wi-Fi, infrared, NFC, etc.). The long range antenna 620 may be configured to communicate with a remote base station and a remote cellular or data network, over the air.

The system memory 602 can be implemented using any combination of any number of non-volatile memories (e.g., flash memory) and volatile memories (e.g. DRAM, SRAM), or any other non-transitory storage medium, or a combination thereof media. The system memory 602 may store computer code, executable by the processor 610, for performing any of the functions described herein. For example, the system memory 602 may comprise a computer readable medium comprising code, executable by the processor 610, for implementing a method as described herein.

For example, the method may include interacting, by the first user device, with a second user device. As a result of the interaction, a transfer application on the first user device receives a second user account identifier from the second user device. In response to receiving the second user account identifier, the transfer application transmits a push transfer message to a processing network. The push transfer message may include at least an amount and the second user account identifier. The processing network transmits the push transfer message to a second authorizing entity computer that credits the amount to a second user account associated with the second user account identifier. According to various embodiments, the transfer application on the first user device is associated with a first user account managed by a first authorizing entity computer, and the amount is debited to the first user account.

The system memory 602 may also store a transfer application 604 and/or an operating system 606. The transfer application 604 may include instructions or code implementing a transfer application 604 for initiating a transfer of funds to a recipient user device. The transfer application 604 may also include code, executable by the processor 610, for obtaining a transfer amount and recipient account identifier, providing the transfer amount and recipient account identifier to a transport computer, and/or forwarding a push transfer message to the processing network computer.

According to various embodiments, the method implemented by executing the code by the processor 610 further includes receiving, by the first user device, scripts for installing the transfer application on the first user device, and associating, on the first user device, a link between the transfer application and a first user account managed by a first authorizing entity computer. An identifier for the first user account is stored on the transfer application on the first user device.

According to various embodiments, the method implemented by executing the code by the processor 610 further includes launching the transfer application on the first user device. The transfer application on the first user device may display instructions for funds transfer on a graphical user interface. The transfer application may receive, via the graphical user interface displayed on the first user device, the amount and a request to transfer the amount to the second user device. The first user device may transmit a message to the second user device asking the second user device (e.g., when the second user device is a communication device or a mobile phone) to be brought in close proximity of the first user device.

In some embodiments, the method implemented by executing the code by the processor 610 further includes launching the transfer application on the first user device. The transfer application on the first user device may receive the amount and a request to transfer the amount to the second user device. The transfer application on the first user device may display a message on the first user device asking the first user device to be brought in close proximity of the second user device.

Embodiments provide various advantages over conventional systems. Embodiments allow transferring funds from a user device linked to a user account (for example via a transfer application) to a recipient device. For example, embodiments allow transferring funds from the sender user account to a payment card of a recipient merely by tapping the payment card to the sender user device (e.g., sender's mobile phone). Embodiments do not require the second user device to have the transfer application or be associated with the transfer server in any way.

Embodiments allow peer-to-peer fund transfer without requiring the recipient device to use a same platform as the sender device.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to embodiments may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of embodiments will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

1. A method comprising:
interacting, by a first user device, with a second user device;
receiving, by a transfer application executing on the first user device from the second user device, a second user account identifier, wherein the second user device is not associated with the transfer application managed by a transfer server; and
transmitting, by the transfer application to a processing network, a push transfer message comprising at least an amount and the second user account identifier,
wherein the transfer application on the first user device is associated with the first user account managed by a first authorizing entity computer, wherein the amount is debited to the first user account,
wherein the push transfer message instructs transfer of the amount from the first user account to a second user account as identified by the second user account identifier,
wherein the processing network transmits the push transfer message to a second authorizing entity computer that credits the amount to the second user account associated with the second user account identifier.

2. The method of claim 1, wherein the first user device is a mobile phone and the second user device is a payment card associated with the second user account.

3. The method of claim 1, wherein the push transfer message is an original credit transaction message.

4. The method of claim 1, wherein the second user device interacts with the first user device by tapping the second user device to the first user device.

5. (canceled)

6. The method of claim 1, wherein the first user device is a first mobile phone and the second user device is a second mobile phone.

7. The method of claim 1, wherein a communication network between the first user device, the second user device and a server managing the transfer application is an open network such that the second user device is devoid of the transfer application.

8. The method of claim 1, wherein the amount includes one or more of a fiat currency, a digital currency, or a cryptocurrency.

9. The method of claim 1, wherein the first user device communicates with the second user device using a near field communication capability of the first user device and the second user device.

10. The method of claim 1, further comprising:
launching the transfer application on the first user device;
displaying, by the transfer application on the first user device, instructions for funds transfer on a graphical user interface;
receiving, by the transfer application via the graphical user interface displayed on the first user device, the amount and a request to transfer the amount to the second user device; and
transmitting, by the first user device, a message to the second user device asking the second user device to be brought in close proximity of the first user device.

11. The method of claim 1, further comprising:
launching the transfer application on the first user device;
receiving, by the transfer application on the first user device, the amount and a request to transfer the amount to the second user device; and
displaying, by the transfer application on the first user device, a message on the first user device asking the first user device to be brought in close proximity of the second user device.

12. The method of claim 1, further comprising:
receiving, by the first user device, scripts for installing the transfer application on the first user device; and
associating, on the first user device, a link between the transfer application and a first user account managed by a first authorizing entity computer, wherein an identifier for the first user account is stored on the transfer application on the first user device.

13. A system comprising:
a first user device comprising one or more processors, and a memory storing a transfer application and instructions that, when executed by the one or more processors, cause the one or more processors to perform the steps of:
interacting with a second user device;
receiving, by a transfer application executing on the first user device from the second user device, a second user account identifier, wherein the second user device is not associated with the transfer application managed by a transfer server; and
transmitting, by the transfer application to a processing network, a push transfer message comprising at least an amount and the second user account identifier,
wherein the transfer application on the first user device is associated with the first user account managed by a first authorizing entity computer, wherein the amount is debited to the first user account,
wherein the push transfer message instructs transfer of the amount from the first user account to a second user account as identified by the second user account identifier,
wherein the processing network transmits the push transfer message to a second authorizing entity computer that credits the amount to a second user account associated with the second user account identifier.

14. The system of claim 13, further comprising the second user device, and wherein the second user device interacts with the first user device using a near field communication capability of the first user device and the second user device.

15. The system of claim 13, wherein the first user device is a mobile phone and the second user device is a payment card associated with the second user account.

16. (canceled)

17. The system of claim 13, wherein a communication network between the first user device, the second user device and a server managing the transfer application is an open network such that the second user device is devoid of the transfer application.

18. The system of claim 13, wherein the instructions, when executed by the one or more processors, further cause the one or more processors to perform the steps of:
launching the transfer application on the first user device;
displaying, by the transfer application on the first user device, instructions for funds transfer on a graphical user interface;
receiving, by the transfer application via the graphical user interface displayed on the first user device, the amount and a request to transfer the amount to the second user device; and
transmitting, by the first user device, a message to the second user device asking the second user device to be brought in close proximity of the first user device; or
displaying, by the transfer application on the first user device, a message on the first user device asking the first user device to be brought in close proximity of the second user device.

19. The system of claim 13, wherein the instructions, when executed by the one or more processors, further cause the one or more processors to perform the steps of:
receiving, by the first user device, scripts for installing the transfer application on the first user device; and
associating, on the first user device, a link between the transfer application and a first user account managed by a first authorizing entity computer, wherein an identifier for the first user account is stored on the transfer application on the first user device.

20. The system of claim 13, wherein the amount includes one or more of a fiat currency, a digital currency, or a cryptocurrency.
